(19) United States
(12) Patent Application Publication
(10) Pub. No.: US 2013/0153552 A1
(43) Pub. Date: Jun. 20, 2013

(54) SCRIBING APPARATUS AND METHOD FOR HAVING ANALYSIS FUNCTION OF MATERIAL DISTRIBUTION

(71) Applicants: Sungho JEONG, Buk-gu (KR); Seokhee Lee, Buk-gu (KR); Hee-Sang Shim, Buk-gu (KR)

(72) Inventors: Sungho JEONG, Buk-gu (KR); Seokhee Lee, Buk-gu (KR); Hee-Sang Shim, Buk-gu (KR)

(73) Assignee: GWANGJU INSTITUTE OF SCIENCE AND TECHNOLOGY, Buk-gu (KR)

(21) Appl. No.: 13/325,578

(22) Filed: Dec. 14, 2011

(51) Int. Cl. B23K 26/36; B23K 26/40

(52) U.S. Cl. 219/121.69; 219/121.68

(57) ABSTRACT

A scribing apparatus having a function to analyze distribution of a material forming a semiconductor or solar cell in real-time in a process producing the semiconductor or solar cell of is disclosed. The scribing apparatus having the analysis function of material distribution comprises: a laser irradiation unit, which conducts scribing by irradiating laser to a position to be scribed of an analysis subject; a spectrum detection optical unit, which detects a spectrum generated from plasma, which is produced by the irradiated laser; a spectrum information storage, which stores spectrum state information of each material forming the analysis subject; and a spectrum analysis unit, which analyzes distribution state information of the material by comparing the spectrum state information and the detected spectrum.

### TECHNICAL FIELD

The present disclosure relates to a scribing apparatus and method having an analysis function of material distribution, more specifically to a scribing apparatus and method which can scribe an analysis subject and analyze material distribution at the same time in a process producing a semiconductor or solar cell.

### BACKGROUND

Plasma produced during laser irradiation emits light of certain wavelength according to a material, and therefore, constituents of the material can be qualitatively or quantitatively analyzed by collecting the light. Laser-induced breakdown spectroscopy (hereinafter, LIBS) as one of the methods analyzing constituents of a material using light is a spectrum analysis technique using plasma, which is produced by causing breakdown, a kind of discharge phenomenon using high power laser, as an excitation source.

A sample is evaporated in the plasma induced by laser, and atoms and ions can exist in an excited state. The excited atoms and ions emit energy after certain life, and then go back to the ground state. At this time, they emit their own wavelengths according to the kind and the excited state of the atoms.

Therefore, constituents of a material can be qualitatively or quantitatively analyzed by analyzing a spectrum of the emitted wavelength.

FIG. 1 is a conceptual scheme representing a concept about the operation principle of LIBS according to the conventionally technique.

Referring FIG. 1, first of all, as shown in step (1), after the infinitesimal amount (several μg) of a material is subjected to ablation (removal of material by melting and vaporization caused by laser) by irradiating pulse laser, the ablated material is ionized within very short time (commonly, within several nano sec) by absorbing the laser energy so as to form plasma having high temperature of about 15000 K or more as shown in step (2). After completing laser pulse, each atom in the plasma expresses its own spectrum while the high temperature plasma is being cooled. The generated spectrum is collected using an analysis apparatus shown in step (3), and analyzed to obtain unique spectrum data of each atom. Finally, the composition analysis is n and amount of the ingredients in the material can be measured by analyzing the data.

LIBS technique is distinguished from other analysis techniques in that \textcircled{1} time consumed to total less than 1 sec, \textcircled{2} separate sampling and pre-treatment processes are not needed for the analysis, \textcircled{3} atomic constitution of the material can be analyzed with nm unit precision while ablating the material in depth because only infinitesimal amount (several μg) of material is required for one analysis, \textcircled{4} separate environment is not needed for the analysis, and the analysis can be conducted in air, \textcircled{5} every atoms except for inert gases can be analyzed with ppm precision, and \textcircled{6} equipments can be made up at relatively low cost.

FIG. 2 is a diagram showing the result of comparing LIBS and other measuring technique.

Referring to FIG. 2, methods commonly used to measure material distribution such as SIMS (Secondary Ion Mass Spectrometry), AES (Atomic Emission Spectroscopy), EDS (Energy Dispersive X-ray Spectroscopy), GD-MS (Glow Discharge Mass Spectrometry) and the like measure the distribution only in a laboratory level but can't be actually applied to a production line because they need high vacuum.

Besides, ICP-MS (Inductively Coupled Plasma-Mass Spectrometry), which is broadly being used, can't be applied to the production line because it has difficulty that a sample to be analyzed should be dissolved in a solvent before analysis. Now, XRF (X-ray Fluorescence), which is mostly used to the analysis of a solar cell material at a laboratory or site due to its convenience in use, has an advantage that the analysis can be conducted in air at relatively low cost, but has technical limits to analyze the material distribution of a CIGS thin film in that \textcircled{1} it is impossible to measure the amount of Na in a CIGS thin film, which has decisive influence on the device efficiency, is impossible because analysis of light weight atoms such as Na, O, N, C, B, Be, Li and the like is almost impossible, \textcircled{2} it is impossible to measure the atomic distribution in depth in a CIGS thin film having the thickness of 2 μm because the precision of XRF in depth is only about 1 μm at most, and \textcircled{3} it is difficult to distinguish whether the measured fluorescence signal is from an actual thin film or from a substrate.

In general, a semiconductor solar cell is defined as a device directly converting sunlight to electricity using photovoltaic effect, wherein electrons are produced when light is irradiated to a p-n junction semiconductor diode. As the most basic constitutional elements, it is divided to three parts such as a front electrode, rear electrode and absorber layer located therebetween. Among theses, the most important material is the absorber layer, which decides most of the photoelectric conversion efficiency, and a solar cell is divided to various kinds according to the material. Particularly, when the material of the absorber layer is composed of I-III-VI₂ compound such as Cu(In,Ga)Se₂, it is called a CIGS thin film solar cell, and the CIGS thin film solar cell, a high-efficient and cheap solar cell, is receiving attention as the most firm second-generation solar cell to replace a crystalline silicon solar cell in a solar cell field where recently fierce competition is taking place all over the world, and it shows the highest efficiency of 20.6%, which is the most close efficiency to a single crystal silicon device.

FIG. 3 is an exemplary diagram schematically representing a structure of a CIGS thin film solar cell as one application area of the present invention, and FIG. 4 is a conceptual scheme representing a schematic production process of a CIGS thin film solar cell as one application area of the present invention.

Referring to FIGS. 3 and 4, first of all, a CIGS thin film solar cell is prepared by sequentially depositing Mo layer, CIGS layer, CdS layer and TCO layer on a substrate, and it is more specifically prepared in detail as follows.

The CIGS thin film module is prepared by, first of all, depositing Mo as a rear electrode layer on a substrate; forming a pattern by a scribing process (P1 scribing); sequentially depositing CIGS layer as an absorber layer and CdS buffer layer on the pattern-formed Mo layer; forming a pattern by a scribing process (P2 scribing); depositing again TCO (transparent conductive oxide) layer on the CdS layer followed by depositing a front electrode grid of Ni/Al; and then finally proceeding a scribing process to form a pattern (P3 scribing). The said scribing process is a patterning process to serially connect the patterns at regular intervals in order to prevent the efficiency reduction caused by increase of the sheet resistance with increased area of the solar cell, and the process is conducted via three times of P1, P2 and P3. Conventionally, the P1 scribing was patterned by laser, and the P2 and P3 scribing were patterned by a mechanical method, but recently, a method using laser to pattern all of the P1, P2 and P3 scribing is being developed.

In case of this CIGS thin film solar cell, it is being reported that not only the thickness of the thin film (1˜2.2 μm) or the device structure but also the composition of the constituent material of the CIGS thin film as a multi-component compound and atomic distribution in the thin film have critical influence on the light absorption rate and photoelectric conversion efficiency. Further, it is being reported that Na, which is diffused from a soda-lime glass largely used as a substrate of the CIGS thin film solar cell to a CIGS absorber layer during a process, increases the photoelectric conversion efficiency by increasing the electric charge concentration of the thin film (Nakada et al., Jpn. J. Appl. Phys., 36, 732 (1997)), or by increasing the grain size of the CIGS single crystal so as to reduce the structural characteristic change according to the composition change (Rockett et al., Thin Solid Films 361-362(2000); Probst et al., Proc. of the First World Conf. on Photovoltaic Energy, Conversion (IEEE, New York, 1994), p. 144).

These reports suggest that the chemical property of the absorber layer should be controlled through the distribution analysis of a material in the thin film for quality control at the CIGS thin film solar cell production line, and that the material distribution analysis in the production line of light emitting diode (LED), transistor, laser diode (LD), photo detector and the like, wherein the said physicochemical characteristics have direct influence on the performance of the product, is essential for quality control.

On the other hand, the continuous production process of the CIGS thin film solar cell is largely divided to a Roll-to-Plate (hereinafter, R2P) process using a hard material substrate such as a soda-lime glass, and a Roll-to-Roll (hereinafter, R2R) process using a soft material substrate such as metal thin plate (e.x., stainless steel, Ti, Mo, Cu and the like) or polymer (e.x., polyimide). Now, the physicochemical property should depend on the previously decided value in the research and development step because a system, which can analyze the physicochemical properties of the CIGS thin film having strong influence on the product performance in real-time, is not equipped yet in these continuous production lines. Further, it is impossible to check separately even if the property is out of the physicochemical standard desired in the actual production process, and therefore, the error should be found out through the decrease of the performance and quality in the evaluation step of the finally completed product, and great product loss is generated.

Now, many efforts and time are consumed to find out physicochemical variables causing great falling off in product performance and quality in products produced through the said continuous production process such as CIGS thin film solar cell, light emitting diode (LED), transistor, laser diode (LD), photo detector and the like), and therefore, there are problems of causing cost increase and falling off in competitiveness.

### SUMMARY

In order to solve the above-mentioned problems, one object of the present invention is to provide a scribing apparatus having a function for analyzing material distribution forming a semiconductor or solar cell in real-time in a process producing a semiconductor or solar cell.

In order to solve the above-mentioned problems, another object of the present invention is to provide a scribing method having a function for analyzing material distribution forming a semiconductor or solar cell in real-time in a process producing a semiconductor or solar cell.

The technical objects of the present invention are not limited to the previously mentioned technical objects, and further another technical objects not mentioned herein can be clearly understood to the skilled person in the art from the following description.

In order to achieve one object of the present invention, one aspect of the present invention, provided is a scribing apparatus having an analysis function of material distribution comprising:
a laser irradiation unit, which conducts scribing by irradiating laser to a position to be scribed of an analysis subject;

a spectrum detection optical unit, which detects a spectrum generated from plasma, which is produced by the irradiated laser;

a spectrum information storage, which stores spectrum state information of each material forming the analysis subject; and

a spectrum analysis unit, which analyzes distribution state of the material by comparing the detected spectrum and the spectrum state information.

In order to achieve another object of the present invention, another aspect of the present invention, provided is a scribing method having an analysis function of material distribution comprising the steps of:

a) conducting scribing by irradiating laser to a position to be scribed of an analysis subject;

b) detecting spectrum generated from plasma which is produced by the irradiated laser; and

c) analyzing distribution state of each material forming the analysis subject by comparing the spectrum state information of the material and the detected spectrum.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual scheme representing a concept about the operation principle of LIBS according to the conventionally technique.

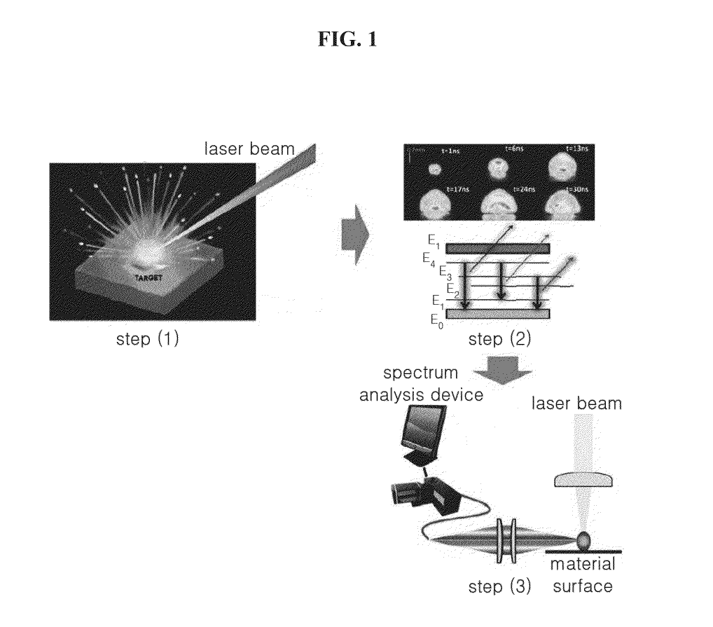

FIG. 2 is a diagram showing the result of comparing LIBS and other measuring technique.

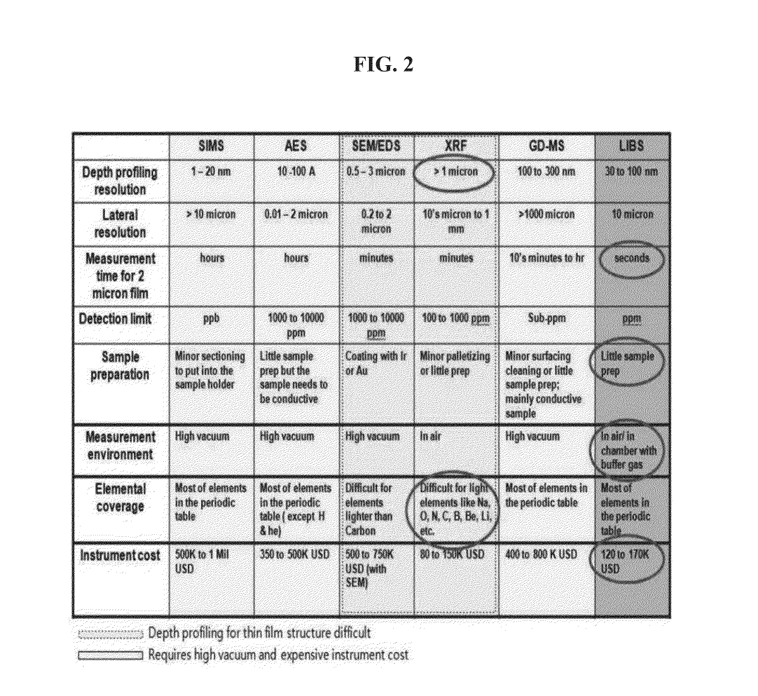

FIG. 3 is an exemplary diagram schematically representing a structure of a CIGS thin film solar cell as one application area of the present invention.

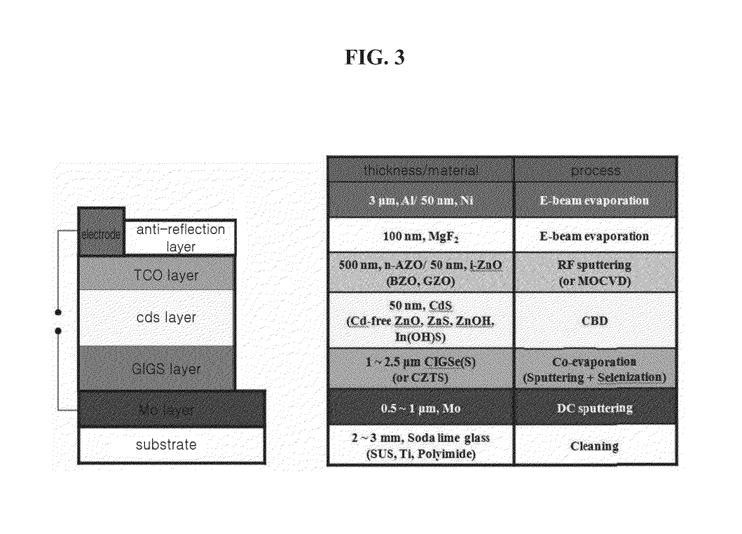

FIG. 4 is a conceptual scheme representing a schematic production process of a CIGS thin film solar cell as one application area of the present invention.

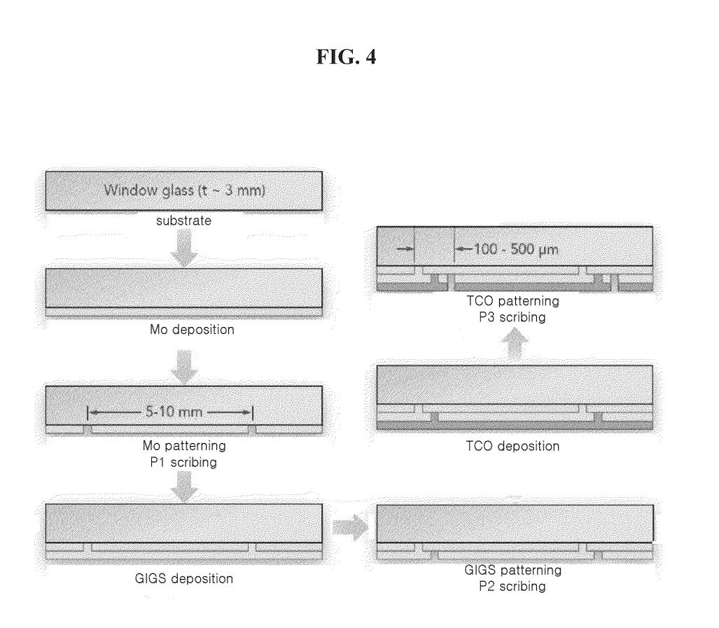

FIG. 5 is an exemplary diagram representing the schematic constitution of the scribing apparatus having an analysis function of material distribution according to one embodiment of the present invention.

FIG. 6 is a perspective view representing the schematic constitution of the scribing apparatus having an analysis function of material distribution according to one embodiment of the present invention.

FIG. 7 is an exemplary diagram representing one embodiment about the operation of the scribing apparatus having an analysis function of material distribution according to one embodiment of the present invention.

FIG. 8 is a flow chart representing the scribing method having an analysis function of material distribution according to one embodiment of the present invention.

DESCRIPTION OF SYMBOLS

| | |
|---|---|
| 100: scribing apparatus | 110: laser irradiation unit |

| | |
|---|---|
| 111: laser module for analysis | 113: laser module for scribing |

| | |
|---|---|
| 115: fine adjustment module | 120: spectrum detection optical unit |

| | |
|---|---|
| 130: spectrum analysis unit | 140: spectrum information storage |

### DETAILED DESCRIPTION

The present invention can make alternations and have various embodiments. Therefore, the embodiments are illustrated in the accompanying drawings and described in detail in the detailed description. However, the present invention is not limited to a predetermined embodiments and it should be understood that the present invention includes all alternations, equivalents or substitutions that are included in the spirit and scope of the present invention. Like elements refer to like reference numerals in describing the accompanying drawings.

Terms such as “first”, “second”, “A”, “B”, etc. may be used in describing various constituent elements, but the constituent elements should not be limited by the terms. The terms are used only for differentiate one constituent element from other constituent elements. For example, a first constituent element may be referred to as a second constituent element without departing from the scope of the appended claims and similarly, the second constituent element may also be referred to as the first constituent element. Terms such as “and/or” include a combination of a plurality of relevant disclosed items or any one of the plurality of relevant disclosed items.

When it is described that one constituent element is “joined” or “connected” to another constituent element, one constituent element may be joined or connected directly to another constituent element, but it will be appreciated that a third constituent element may be provided therebetween. On the contrary, when it is described that one constituent element is “directly joined” or “directly connected” to another constituent element, it will be appreciated that no constituent element is provided therebetween.

Terms used in this application are used for just describing predetermined embodiments and not used for limiting the present invention. Expression of the singular number includes expression of the plural numbers I f the singular number does not have a meaning different from the plural numbers. In this application, it will be appreciated that terms “include” or “have” are used for indicating that characteristics, numbers, steps, operations, constituent elements, components or combinations thereof are provided and existence or adding possibility of one or more different characteristics or numbers, steps, operations, constituent elements, components, and combinations thereof is not previously excluded.

If not differently defined, all terms disclosed herein including technical or scientific terms have the same meanings as those generally by those skilled in the art. It should be understood that generally used terms that are defined in dictionaries have meanings that coincide with contextual meanings of relevant technologies and if definitely defined in this application, the terms should not be interpreted as ideal or excessively formal meanings.

Hereinafter, preferred embodiments of the present invention will be described in detail with reference to the accompanying drawings.

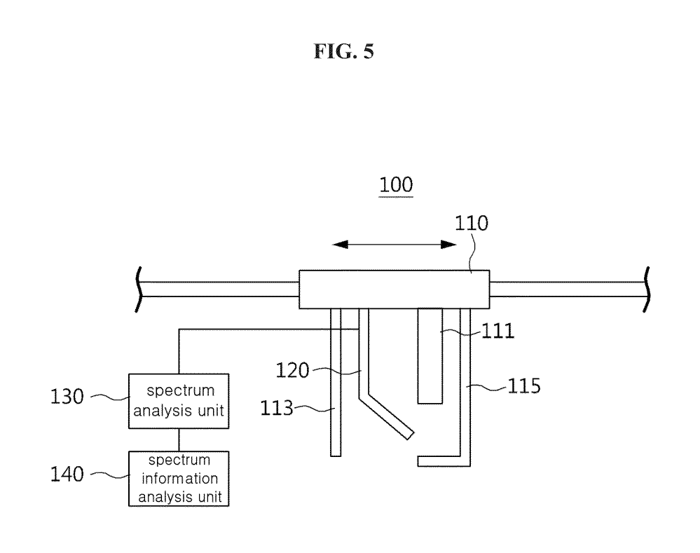

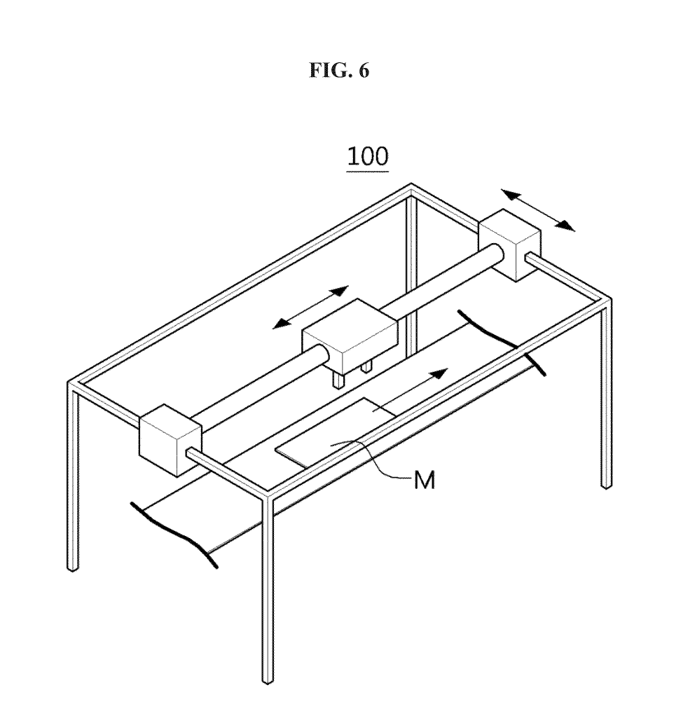

FIG. 5 is an exemplary diagram representing a schematic constitution of the scribing apparatus having an analysis function of material distribution according to one embodiment of the present invention, and FIG. 6 is a perspective view representing a schematic constitution of the scribing apparatus having an analysis function of material distribution according to one embodiment of the present invention.

Referring to FIGS. 5 and 6, the scribing apparatus (100) having an analysis function of material distribution irradiates laser for scribing to a semiconductor or solar cell as an analysis subject in the semiconductor or solar cell production process. A spectrum generated from plasma, which is produced from the irradiated laser is detected, and unique spectrum state information of the analysis subject is stored in a spectrum information storage (140), which will be described later.

The constitution and material distribution of the analysis subject can be measured by comparing the detected spectrum and the previously stored spectrum state information.

The scribing apparatus (100) having the analysis function of material distribution comprises a laser irradiation unit (110), a spectrum detection optical unit (120), a spectrum information storage (140) and spectrum analysis unit (130).

The laser irradiation unit (110) can conduct scribing by irradiating laser to the position to be scribed of the analysis subject such as solar cell or semiconductor. The laser may be various lasers such as ND:YAG laser, Nd:YLF laser, ND:YV04 laser and the like. Further, a pulse width, energy density, wavelength and the like can be differently set according to physical properties of the analysis subject.

The laser irradiation unit (100) can comprise a laser module for scribing (113), laser module for analysis (111) and position adjustment module (115).

The laser module for scribing (113) is to scribe the analysis subject such as semiconductor or solar cell, and can irradiate laser for scribing to the position to be scribed o the analysis subject.

The laser module for analysis (111) can irradiate laser for analyzing the constitution and distribution state of each material forming the analysis subject such as a semiconductor or solar cell.

The lasers of the laser module for scribing and the laser module for analysis may be various laser such as ND:YAG laser, Nd:YLF laser, ND:YV04 laser and the like, and the laser for scribing and the laser for analysis can be the same laser.

Further, the laser irradiation unit (110) can irradiate laser to the position to be scribed by enabling only the laser module for scribing (113) when the scribing and the distribution state analysis of the material are conducted at the same time.

Further, when the scribing and the distribution state analysis of the material are not conducted at the same time, first of all, it irradiates laser to the position to be scribed by enabling the laser module for analysis (111) to analyze the constitution and the distribution state of each material forming the analysis subject, and then irradiates laser to the position to be scribed by enabling the laser module for scribing (113) to scribe the analysis subject.

The position to be analyzed by the laser may be a defected region or a dead area not to be produced.

The position adjustment module (115) can adjust at least one of irradiation position and angle to make at least one of the laser module for scribing (113) and laser module for analysis (111) irradiate laser to the position to be scribed. The position adjustment module (115) may be a galvanometer which can conduct a function reflecting the irradiated laser through at least one of a reciprocating motion and rotational motion.

The spectrum detection optical unit (120) can detect a spectrum produced from plasma generated by the laser irradiated from the laser irradiation unit, and can use a high precision optical device such as echelle spectrometer, a high sensitivity detector such as an Intensified Charge Coupled Device (ICCD) and the like.

Further, the spectrum detection optical unit (120) can control a time point (delay) and time (gate) to detect the generated spectrum on the basis of the characteristics of the analysis subject.

Each element forming the analysis subject has its own characteristic because in the plasma produced by the irradiated laser, an unique signal of each atom making up the analysis subject is converted to a spectrum while background signal is gradually reduced from the state that lights of every wavelength are emitted at the same time (continuous emission) according to the time. Therefore, the time point (delay) measuring the spectrum, which means when the spectrum is measured after the plasma is generated, and the time (gate) measuring the spectrum, which means how long the spectrum is measured are important parameters. And, the time point and the time measuring the spectrum can be set in consideration of the said characteristics of the analysis subject because they are affected by various parameters such as whether the analysis subject is solid or liquid, whether it is a single material or composite, whether it is a metal or non-metal and the like.

The spectrum information storage (140) can store spectrum state information of each material forming the analysis subject such as a semiconductor or solar cell.

Specifically, the spectrum state information stored in the spectrum information storage can comprise information about a spectrum corresponding to each material forming the analysis subject such as a semiconductor or solar cell, and preferably, information about a spectrum corresponding to each material forming the standard subject as an analysis subject.

The spectrum analysis unit (130) can analyze distribution state of the material forming the analysis subject by comparing the spectrum state information stored in the spectrum information storage (140) and the spectrum detected at the spectrum detection optical unit (120).

Further, when the distribution of each material forming the analysis subject is changed, a depth profiling can be conducted to the position to be scribed of the analysis subject, and it can analyze the spectrum generated from plasma produced by the irradiated laser for scribing, preferably, but not limited thereto.

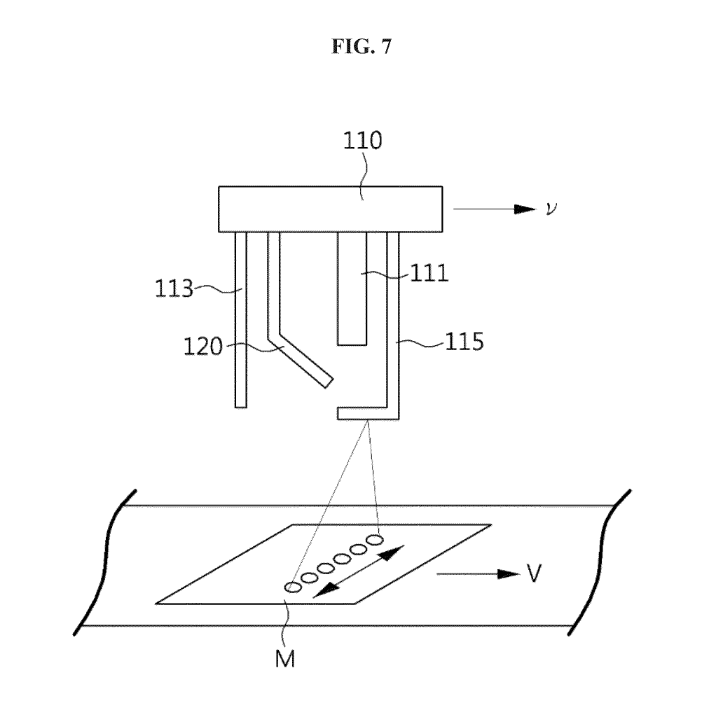

FIG. 7 is an exemplary diagram representing one embodiment about the operation of the scribing apparatus having an analysis function of material distribution according to one embodiment of the present invention.

Referring to FIG. 7, the apparatus has the same constitution, and the explanations of the same constitutional elements with those of the scribing apparatus having an analysis function of the material distribution illustrated in FIG. 5 are omitted, and hereinafter, the linkage with the analysis subject is described.

The scribing apparatus having an analysis function of material distribution (100) can be moved in combination with the movement of the analysis subject (M) such as a semiconductor or solar cell. For example, when a CIGS solar cell (M) as the analysis subject is moved right at a rate of V, the scribing apparatus having an analysis function of the material distribution moves in combination with the analysis subject so as to irradiate laser to the position to be scribed.

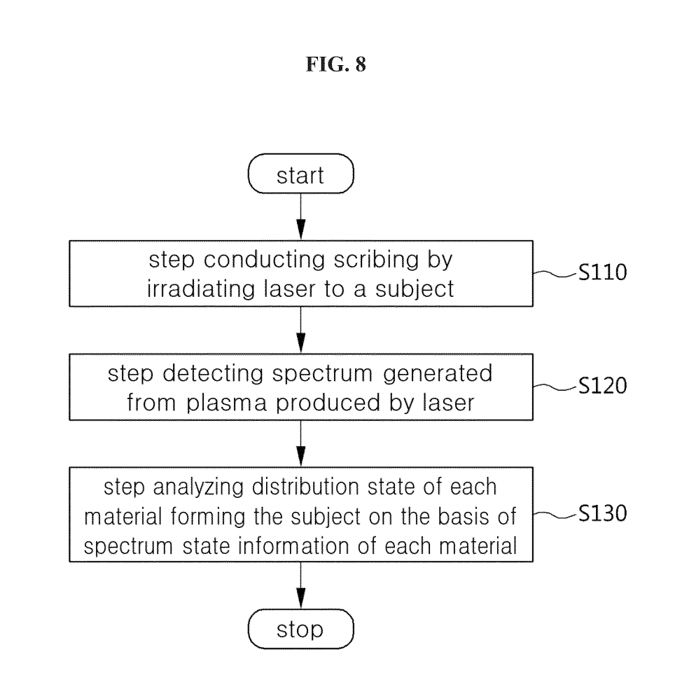

FIG. 8 is a flowchart representing the scribing method having an analysis function of material distribution according to one embodiment of the present invention.

Referring to FIG. 8, the scribing method having a function analyzing the material forming a semiconductor or solar cell as a subject to measure material distribution can conduct scribing by irradiating laser to a position to be scribed of the analysis subject (S 110), and can detect a spectrum generated from plasma which is produced by the irradiated laser (S 120).

Further, the generated spectrum can be detected by controlling a time point (delay) and time (gate) to detect the generated spectrum on the basis of the characteristics of the analysis subject.

The distribution state of each material forming the analysis subject can be analyzed by using the spectrum which is detected by comparing the spectrum state information of each material forming the analysis subject and the detected spectrum (S 130).

Further, when the scribing and the distribution state analysis of the material are not conducted at the same time, first of all, laser is irradiated to the position to be scribed to analyze the distribution state of each material forming the analysis subject, and then laser is irradiated again to the position to be scribed to scribe the analysis subject.

Further, the scribing method having an analysis function of material distribution can analyze the material distribution in thickness direction by conducting a depth profiling to the position to be scribed of the analysis subject according to a certain period when material distribution of each material forming the analysis subject is changed.

Further, the position to be analyzed by laser may be a defected region or a dead area not to be produced.

Distribution of a material forming a semiconductor or solar cell can be accurately analyzed in real-time by using the scribing apparatus and method having an analysis function of material distribution according to the present invention.

Further, a scribing process, which is essentially conducted in a process producing the semiconductor or solar cell, is conducted simultaneously with analyzing the distribution of the material forming the semiconductor or solar cell. Therefore, production time is reduced because there is no need to conduct a separate analyzing process followed by reducing production cost, and consequently the productivity can increase.

Further, the present invention has an advantage that the material distribution can be analyzed without damage of a region to be produced, and a separate ablation to generate plasma for the material distribution analysis is not needed.

Further, the distribution of a material forming an analysis subject can be analyzed simultaneously with measuring the thickness of the subject using depth profiling.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A scribing apparatus having an analysis function of material distribution comprising:
a laser irradiation unit, which conducts scribing by irradiating laser to a position to be scribed of an analysis subject;
a spectrum detection optical unit, which detects a spectrum generated from plasma, which is produced by the irradiated laser;
a spectrum information storage, which stores spectrum state information of each material forming the analysis subject; and
a spectrum analysis unit, which analyzes distribution state of the material by comparing the detected spectrum and the spectrum state information.

2. The scribing apparatus having an analysis function of material distribution of claim 1, wherein the laser irradiation unit comprises: a laser module for scribing, which irradiates laser for scribing to the position to be scribed; and a laser module for scribing, which analyzes distribution state of each material forming the analysis subject.

3. The scribing apparatus having an analysis function of material distribution of claim 2, wherein the laser irradiation unit further comprises: a position adjustment module, which adjusts at least one of irradiation position and angle to make at least one of the laser module for scribing and laser module for analysis irradiate laser to the position to be scribed.

4. The scribing apparatus having an analysis function of material distribution of claim 2, wherein the laser irradiation unit irradiates laser to the position to be scribed by enabling only the laser module for scribing when the scribing and the distribution state analysis of the material are conducted at the same time; and when the scribing and the distribution state analysis of the material are not conducted at the same time, first of all, it irradiates laser to the position to be scribed by enabling the laser module for analysis to analyze the distribution state of each material forming the analysis subject, and then irradiates laser to the position to be scribed by enabling the laser module for scribing to scribe the analysis subject.

5. The scribing apparatus having an analysis function of material distribution of claim 1, wherein the spectrum state information is unique spectrum characteristic information to each material forming the analysis subject.

6. The scribing apparatus having an analysis function of material distribution of claim 1, wherein the spectrum detection optical unit controls a time point (delay) and time (gate) to detect the generated spectrum on the basis of the characteristics of the analysis subject.

7. The scribing apparatus having an analysis function of material distribution of claim 6, wherein the characteristics of the analysis subject are information about phase, physical properties and chemical properties of the analysis subject.

8. A scribing method having an analysis function of material distribution comprising the steps of:
a) conducting scribing by irradiating laser to a position to be scribed of an analysis subject;
b) detecting spectrum generated from plasma which is produced by the irradiated laser; and
c) analyzing distribution state of each material forming the analysis subject by comparing the spectrum state information of the material and the detected spectrum.

9. The scribing method having an analysis function of material distribution of claim 8, which conducts depth profiling to the position to be scribed of the analysis subject when the distribution of each material forming the analysis subject is changed.

10. The scribing method having an analysis function of material distribution of claim 8, wherein the step conducting scribing by irradiating laser to the position to be scribed of the analysis subject comprising the steps of when the scribing and the distribution state analysis of the material are not conducted at the same time:
a) analyzing the distribution state of each material forming the analysis subject by irradiating laser to the position to be scribed; and
b) scribing the analysis subject by irradiating laser to scribe the analyzed position to be scribed.

11. The scribing method having an analysis function of material distribution of claim 8, wherein the position to be scribed is a dead area or defect position as a position to analyze distribution of the analysis subject material.

12. The scribing method having an analysis function of material distribution of claim 8, wherein the step of detecting spectrum generated from plasma which is produced by the irradiated laser is to control a time point (delay) and time (gate) to detect the generated spectrum on the basis of the characteristics of the analysis subject.

13. The scribing method having an analysis function of material distribution of claim 8, wherein the spectrum state information is unique spectrum characteristic information to each material forming the analysis subject.
